(19) United States
(12) Patent Application Publication
(10) Pub. No.: US 2025/0310618 A1
(43) Pub. Date: Oct. 2, 2025

(54) ARTIFICIAL INTELLIGENCE-BASED FIGHTING VIDEO BROADCASTING APPARATUS AND METHOD

(71) Applicant: CJ OliveNetworks Co., Ltd., Seoul (KR)

(72) Inventors: Yi An SEO, Seoul (KR); Yae Ha KWON, Seoul (KR); Jongsoo SOHN, Seoul (KR); Chi Hoon LEE, Seoul (KR)

(21) Appl. No.: 19/237,075

(22) Filed: Jun. 13, 2025

Related U.S. Application Data
(63) Continuation of application No. PCT/KR2023/019886, filed on Dec. 12, 2023.

(30) Foreign Application Priority Data
Dec. 14, 2022 (KR) 10-2022-0174708

(51) Int. Cl. H04N 21/81; H04N 21/233; H04N 21/234; H04N 21/488

(52) U.S. Cl. CPC H04N 21/8133; H04N 21/233; H04N 21/23418; H04N 21/4884

(57) ABSTRACT

A method of broadcasting fighting video and an apparatus for the same are disclosed. The method of broadcasting a fighting video obtained by filming a fighting game in which two players compete according to established rules, which is executed by a fighting video broadcasting apparatus, comprises the steps of acquiring characteristic information about each of both players in the fighting game based on player information collected in advance before the start of the fighting game; generating a first viewing guide view representing at least a portion of the characteristic information; processing the fighting video to obtain game progress situation information of the fighting game; and generating a second viewing guide view representing at least a portion of the game progress situation information.

### TECHNICAL FIELD

The present invention relates to a video broadcasting technology and more particularly, the present invention relates to an apparatus and method for automatically generating and providing viewing guide contents for the broadcast video of a fighting game, in which both players compete according to established rules, based on artificial intelligence (AI) to thereby deliver a high sense of immersion and liveliness to viewers of the fighting game.

### BACKGROUND ART

The domestic Over the Top (OTT) usage rate has grown rapidly from about 41% in 2019 to about 82% in 2021 and accordingly, an environment where numerous video contents can be viewed anytime and anywhere has been created, but there is a strong aspect that the consumption of sports-related video content is relatively low.

Except for a few sports or leagues with a strong fan base, smooth consumption of broadcast video contents is not achieved compared to efforts to secure broadcasting rights on OTT platform, and in contrast to more popular contents such as movies and dramas which have a high level of membership attraction power in themselves, the reality is that broadcast video content of sports events remains in the role of the level of bait products to induce OTT subscriptions.

As traditional popular sport events benefit from their high popularity and strong fan base, various broadcasting services utilizing the AI technology are being attempted. For example, in soccer, technologies are being developed to predict the success rate of passes between two players based on the position of each player, the distance between them and the like or to predict in real time whether the opposing team's defender will make a successful tackle, for example. In baseball, a technology has been introduced that accurately presents the swing trajectory by expanding the frame of the batter's swing section based on the afterimage effect.

In contrast, several types of fighting sports including the Ultimate Fighting Championship (UFC) do not yet have a large demand and have a relatively strong enthusiastic personality, SO there have been tardy convergence with the aforementioned AI technology. Because of this, it is difficult to narrow the viewership gap between traditional popular sports and fighting sports.

### DISCLOSURE

### Technical Problem

The present invention has been invented to solve the above problems, and it is an object of the invention to provide a method and apparatus for extracting additional information (interest-generating elements, etc.) related to the fighting game from player information collected before the start of the fighting game and broadcast video received during the fighting and for generating a viewing guide view that can be visually confirmed by a viewer based on the extracted additional information.

Also, it is an object of the invention to provide a method and an apparatus for mapping a viewing guide view to a broadcast video so that a viewer can select and confirm a viewing guide view corresponding to the viewer's desired category while the broadcast video of the fighting game is streaming or playing on the viewer's multimedia terminal (e.g., TV, smartphone, tablet PC, etc.).

Other objects and advantages of the present invention can be understood from the following description and will be more clearly understood from embodiments of the present invention. In addition, it will be readily appreciated that the objects and advantages of the present invention can be realized by features and combination thereof recited in the claims.

### Technical Solution

In order to solve the problem mentioned above, a method of broadcasting a fighting video according to one embodiment of the present invention relates to a method of broadcasting a fighting video obtained by filming a fighting game in which both players compete according to established rules, which is executed by a fighting video broadcasting apparatus.

The method of broadcasting a fighting video may comprise the steps of: acquiring characteristic information about each of both players in the fighting game based on player information collected in advance before the start of the fighting game; generating a first viewing guide view representing at least a portion of the characteristic information; processing the fighting video to obtain game progress situation information of the fighting game; and generating a second viewing guide view representing at least a portion of the game progress situation information.

Also, according to the method of broadcasting a fighting video, the player information may include at least one of physical specification for each player, winning/losing history, fighting style, attack attempt/success history for each game, defense attempt/success history for each game, progress time for each game and game preparation situation, the characteristic information may include at least one of physical strength and weakness, special skill and strength and weakness compared to the opposing player, and the game progress situation information may include at least one of the emotional state, body state, and attempted attack and defense technique for each player.

Also, according to the method of broadcasting a fighting video, the first viewing guide view may include at least one of a fighting characteristic keyword of at least one of the both players in the fighting game, a level of the fighting characteristic keyword and a winning probability, which are extracted from the characteristic information.

Also, according to the method of broadcasting a fighting video, the game progress situation information may include at least one of a first progress situation information representing the player status of both players, a second progress situation information representing the attack and defense situation between the both players and a third progress situation information representing a stadium environment where the fighting game is held, which are expressed in the fighting video during the fighting game.

Also, according to the method of broadcasting a fighting video, the step of acquiring game progress situation information of the fighting game may comprise inputting the fighting video into an emotion analysis model to detect the emotional state of each player in the fighting game; and inputting the fighting video into a body analysis model to detect the physical condition of each player in the fighting game, wherein the first progress situation information may represent at least one of the emotional state and the physical state for each player,

Also, according to the method of broadcasting a fighting video, the step of acquiring game progress situation information of the fighting game may comprise inputting the fighting video into a posture analysis model to detect a fighting posture for each player in the fighting game; and inputting the fighting video into a motion analysis model to detect fighting movement for each player in the fighting game, wherein the second progress situation information may represent at least one of the fighting posture and the fighting movement for each player.

Also, according to the method of broadcasting a fighting video, the step of acquiring game progress situation information of the fighting game may comprise inputting the fighting video into an audio analysis model to convert speech signal uttered by at least one of a player, referee, coach and spectator during the fighting game into text; and inputting the speech signal into a speaker analysis model to identify a speaker as an uttering source of the speech signal among the player, referrer, coach and spectator, wherein the third progress situation information may represent at least one of the text and the speaker.

Also, the method of broadcasting a fighting video may further comprise the step of mapping at least one of the first viewing guide view and the second viewing guide view to an image section of the fighting video corresponding thereto

Also, the method of broadcasting a fighting video may further comprise the steps of inputting the game progress situation information into a match prediction model to thereby acquire a match prediction information including at least one of the probability of winning of at least one of the both players in the fighting game, the type of winning, and the remaining time until before the decision of winning or losing; and generating a third viewing guide view representing at least a portion of the match prediction information.

Also, according to the method of broadcasting a fighting video, the remaining time until the decision of winning or losing may be predicted in the condition that the probability of winning is greater than a reference value and the type of winning has been predicted as a knock out (KO) or submission.

Also, the method of broadcasting a fighting video may further comprise the steps of: predicting a start time of other fighting game scheduled after the fighting game based on the remaining time until the decision of winning or losing; and generating a fourth viewing guide view representing the predicted start time for the other fighting game.

Meanwhile, an apparatus for broadcasting a fighting video according to another embodiment of the present invention relates to an apparatus for broadcasting a fighting video obtained by filming a fighting game in which both players compete according to established rules.

The apparatus for broadcasting a fighting video may comprise a memory storing a computer program in which instructions for executing a fighting video broadcasting method are recorded; and a processor operably coupled to the memory, wherein when the computer program is executed by the processor, the computer program may cause the processor to acquire characteristic information about each of both players in the fighting game based on player information collected in advance before the start of the fighting game; generate a first viewing guide view representing at least a portion of the characteristic information; process the fighting video to acquire game progress situation information of the fighting game; and generate a second viewing guide view representing at least a portion of the game progress situation information.

Also, according to the apparatus for broadcasting a fighting video, the first viewing guide view may include at least one of a fighting characteristic keyword of at least one of the both players in the fighting game, a level of the fighting characteristic keyword and a winning probability, which are extracted from the characteristic information.

Also, according to the apparatus for broadcasting a fighting video, the game progress situation information may include at least one of a first progress situation information representing the player status of both players, a second progress situation information representing the attack and defense situation between the both players and a third progress situation information representing a stadium environment where the fighting game is held, which are expressed in the fighting video during the fighting game.

Also, according to the apparatus for broadcasting a fighting video, the computer program may cause the processor to input the game progress situation information into a match prediction model to thereby acquire a match prediction information including at least one of the probability of winning of at least one of the both players in the fighting game, the type of winning, and the remaining time until before the decision of winning or losing; and generate a third viewing guide view representing at least a portion of the match prediction information.

### Advantageous Effects

According to at least one of the embodiments of the present invention, additional information (interest-generating elements, etc.) related to the fighting game is extracted from player information collected before the start of the fighting game and broadcast video received during the fighting game, and a viewing guide view that can be visually confirmed by a viewer based on the extracted additional information can be generated.

Also, according to at least one of the embodiments of the present invention, a viewing guide view can be mapped by video section of a broadcast video so that a viewer can select and confirm a viewing guide view corresponding to the desired category while the broadcast video of the fighting game is streaming or playing on the viewer's multimedia terminal (e.g., TV, smartphone, tablet PC, etc.).

In addition, according to at least one of the embodiments of the present invention, a match prediction for both players in a fighting game is provided as basic information before the start of the game based on the past game history of both players, etc., and then by detecting the constantly changing status of both players, attack/defense situation and stadium atmosphere from the broadcast video during the actual fighting game, the superiority level and match prediction information for each player can be provided in real time or in a timely manner according to the viewer's request.

The effects of the present invention are not limited to the effects mentioned above, and other effects not mentioned will be clearly understood by those skilled in the art from the features recited in the claims.

### DESCRIPTION OF DRAWINGS

The following drawings attached to this specification illustrate preferred embodiments of the present invention, and serve to aid a complete understanding of the technical idea of the present invention together with the detailed description of the invention which will be described later, and thus the present invention should not be interpreted as limited to only the matters described in such drawings.

FIG. 1 is a diagram illustrating the configuration of a fighting video broadcasting system according to the present invention.

FIG. 2 is a schematic diagram used to schematically explain the configuration of the fighting video broadcasting apparatus shown in FIG. 1.

FIG. 3 is a diagram referenced to explain the function of a processor provided in the fighting video broadcasting apparatus shown in FIG. 2.

FIG. 4 is a diagram illustrating artificial intelligence models stored in the artificial intelligence model storage shown in FIG. 1.

FIG. 5 is a flowchart referenced to illustratively explain a fighting video broadcasting method according to an embodiment of the present invention.

FIGS. 6 to 8 are diagrams referenced to illustratively explain the screen configuration of a user terminal that connects to the fighting video broadcasting apparatus shown in FIG. 1 through a wired or wireless communication network and that receives a fighting video broadcasting service.

FIG. 9 is a flowchart schematically showing a fighting video broadcasting method according to another embodiment of the present invention.

### MODE FOR INVENTION

Details regarding the objects and technical configuration of the present invention and its acting effects will be more clearly understood by the following detailed description based on the drawings attached to the specification of the present invention. Embodiments according to the present invention will be described in detail with reference to the attached drawings.

The embodiments disclosed in the present specification should not be construed or used as limiting the scope of the present invention. It is obvious to those skilled in the art that the description including embodiments of this specification has various applications. Accordingly, any embodiments described in the detailed description of the present invention are only illustrative to better explain the present invention and are not intended to limit the scope of the present invention to the embodiments.

The functional blocks shown in the drawings and described below are only examples of possible implementations. Other functional blocks may be used in other implementations without departing from the spirit and scope of the detailed description. Also, although one or more functional blocks of the present invention are shown as individual blocks, one or more of the functional blocks of the present invention may be a combination of various hardware and software components that execute the same function.

Terms containing ordinal numbers such as first, second, etc., are used for the purpose of distinguishing any one of the various components from the rest, and are not used to limit the components by such terms.

Also, the expression including any component is an “open” expression and simply refers to the presence of the corresponding components, and should not be understood as excluding additional components.

Furthermore, when a component is referred to as being “connected” or “coupled” to another component, it should be understood that although it may be directly connected or coupled to the other component, another component may be interposed therebetween.

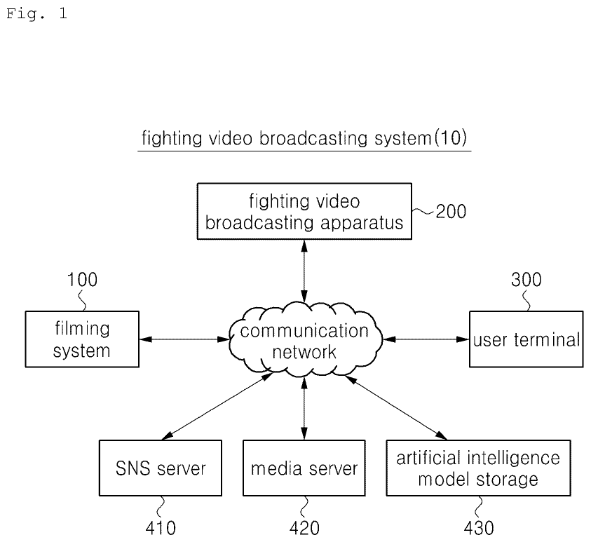

FIG. 1 is a diagram illustrating the configuration of a fighting video broadcasting system 10 according to the present invention.

Referring to FIG. 1, the fighting video broadcasting system 10 includes a filming system 100, a fighting video broadcasting apparatus 200, and a user terminal 300.

The filming system 100 includes a plurality of cameras disposed in a stadium where one or more scheduled fighting games are held, and the plurality of cameras interwork with each other to film situations before the start of the fighting game, during the game and after the game. The places of the fighting game filmed by each camera are recorded in the form of video and then transmitted to the fighting video broadcasting apparatus 200.

The fighting video broadcasting apparatus 200 (hereinafter referred to as the ‘broadcasting apparatus 200’) is provided to receive the fighting video from the filming system 100, analyze the received fighting video and generate one or more related viewing guide views. The specific operation of the broadcasting apparatus 200 will be described later.

The user terminal 300 receives a fighting video and a viewing guide view through the fighting video, and displays the fighting video on at least a portion of a screen provided therein. At this time, on the screen of the user terminal 300 may be displayed the viewing guide view together with the fighting video in a form that the viewing guide view is connected to the fighting video, adjacent to the fighting video or overlaps with the fighting video. The type of the user terminal 300 is not particularly limited as long as it has a video data reception function, an information display function, a sound output function and a user input reception function like a smartphone or tablet PC, etc.

The filming system 100, the broadcasting apparatus 200 and the user terminal 300 may be directly or indirectly connected to each other through a wired or wireless communication network. For example, the user terminal 300 may run an app installed on the user terminal 300, connect to the broadcasting apparatus 200, and then receive a streaming service of the fighting video.

The fighting video broadcasting system 10 may further include at least one of an SNS server 410, a media server 420 and an artificial intelligence model storage 430, and these configurations can also be connected directly or indirectly to the broadcasting apparatus 200 through a wired or wireless network.

In response to the request from the broadcasting apparatus 200, the SNS server 410 and the media server 420 may provide the broadcasting apparatus 200 with information which is related to both players of the fighting game and which has been recorded within a predetermined time from the scheduled start time of the fighting game. For example, if a fighting game between players A and B is scheduled to start at 1 p.m. on Mar. 31, 2022, prior to that, the broadcasting apparatus 200 may request at least one of the SNS server 410 and media server 420 to send information related to players A and B, and the SNS server 410 and the media server 420 may return information related to players A and B recorded during the last three months (i.e., Jan. 1 to Mar. 31, 2022) from the time of the request to the broadcasting apparatus 200. The information related to the players may include, for example, training Camp period/place, injury/illness, congratulations and condolences, sparring partners, posts and conversations of members recorded in online fighting communities, etc.

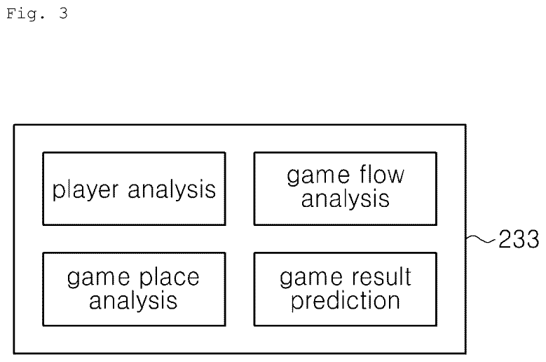

The artificial intelligence model storage 430 stores a plurality of artificial intelligence models used to extract (estimate, predict) each categories related to the fighting game. The plurality of artificial intelligence models will be described in more detail later with reference to FIG. 3.

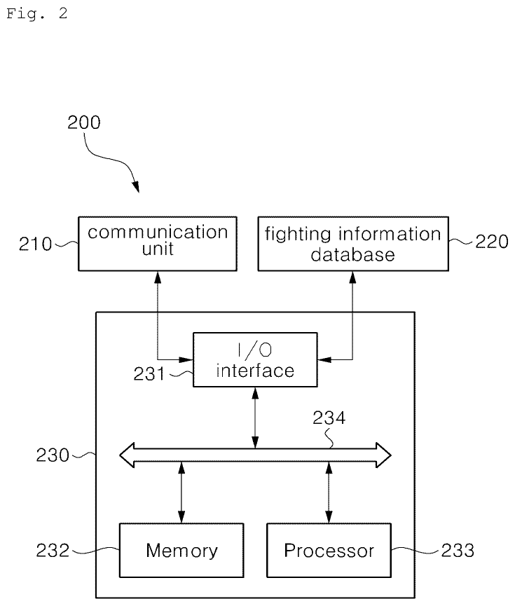

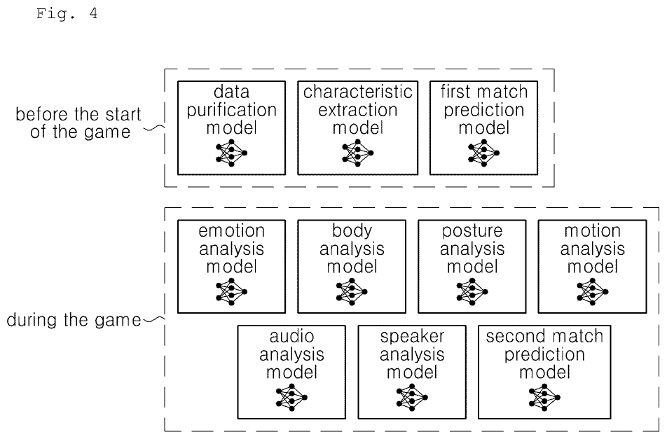

FIG. 2 is a schematic diagram referenced to schematically explain the configuration of the fighting video broadcasting apparatus 200 in FIG. 1, and FIG. 3 is a diagram referenced to explain the function of a processor 233 provided in the fighting video broadcasting apparatus 200 shown in FIG. 2, and FIG. 4 is a diagram illustrating artificial intelligence models stored in the artificial intelligence model storage 430 shown in FIG. 1.

First, referring to FIG. 2, the broadcasting apparatus 200 includes a communication unit 210, a fighting information database 220, and a control unit 230.

The communication unit 210 receives the original video of the fighting game from the filming system 100 through a wired or wireless network. Also, the communication unit 210 may perform an operation of broadcasting the fighting video to the user terminal 300 in response to a broadcasting service request from the user terminal 300 received through a wired or wireless communication network and in parallel, the communication unit 210 may transmit at least one viewing guide view which is a visualized view of the result data of processing of the fighting video by the control unit 230 to the user terminal 300. Each viewing guide view has been mapped to some video sections or specific time code of the fighting video and thus, the user terminal 300 may selectively display the corresponding viewing guide view on the screen according to the user's manipulation.

The fighting information database 220 stores history information about scheduled fighting games and past fighting games of the same event, profile information for each player and competition information. Specifically, these information may include the following information about each fighters registered in the pool of fighters of the relevant fighting sports: age, weight class, nationality, fighting base (e.g., MMA, karate, taekwondo, boxing, freestyle, judo), physical specification (e.g., reach, height), and main attack technique, weigh-in failure history, winning/losing history for each game, place/time of winning game, place/date/time of losing game, attack attempt/success history for each game, defense attempt/success history for each game, progress time for each game (the game may end before the stipulated regular game time has elapsed due to KO, surrender, injuries, etc.), statistical data for each fighting technique (e.g., number of takedown attempts per game, takedown success/defense rate), winning/losing rate by KO, winning/losing rate by decision, winning/losing rate by submission, player information about the winning opposing player, player information about the losing opposing player, etc. Of course, the information types listed above are relevant to examples that can be recorded in the fighting information database 220, and it will be fine only some of them may be recorded, or other additional types of information may be recorded in the fighting information database 220. For example, the winning/losing rate by KO may be subdivided into KO by punch and KO by kick.

Competition information may include the game-held place (e.g., North Carolina, USA) for each competition having one or more fighting games, game-held time, order of competition (limited to competitions having two or more fighting games), altitude above sea level, number of spectators, number of viewers, etc.

The control unit 230 includes an input/output interface 231, a memory 232, a processor 233, and a data bus 234 connecting them to enable mutual communications.

The input/output interface 231 transmits data/information collected from the communication unit 210 and the fighting information DB 220 to the processor 233 through the data bus 234, and the processor 233 sends the result data such as the viewing guide view generated by processing the broadcasting video to the communication unit 210.

The memory 232 records a certain sports broadcast video, a learning model required to support an editor in creating a highlight video containing the editor's desired video sections from the sports broadcast video, and a computer program and/or data. The memory 232 may include, as hardware-wise storage medium types, at least one or two or more of a flash memory 232, a hard disk, a solid state disk (SSD), a silicon disk drive (SDD), a multimedia card micro, a random access memory (RAM), a static random access memory (SRAM), a read-only memory (ROM), an electrically erasable programmable read-only memory (EEPROM) and a programmable read-only memory (PROM). The memory 232 may include a storage medium having stored therein a computer program encoded with instructions for executing the fighting video broadcasting method according to the present invention.

The processor 233 is operably coupled to the communication unit 210 and the memory 232 and controls the overall operation of the broadcasting apparatus 200. The processor 233 may include at least one of application-specific integrated circuits (ASICs), digital signal processors (DSPs), digital signal processing devices (DSPDs), programmable logic devices (PLDS), field programmable gate arrays (FPGAS), microprocessors 233, and electrical units for performing other functions.

Referring to FIG. 3, the processor 233 may have a player analysis function, a game flow analysis function, a game place analysis function and a game result prediction function. In order to perform operations according to respective functions, the processor 233 can call an application programming interface (API) to selectively execute only the necessary artificial intelligence model among the plurality of artificial intelligence models stored in the artificial intelligence model storage 430. In FIG. 1, the artificial intelligence model storage 430 is shown as an independent configuration from the broadcasting apparatus 200, but depending on the implementations, the broadcasting apparatus 200 may also include the artificial intelligence model storage 430.

Referring to FIG. 4, the plurality of artificial intelligence models stored in the artificial intelligence model storage 430 may be largely divided into artificial intelligence models used ‘before the start of the game’ and artificial intelligence models used ‘during the game’ of a fighting game.

Artificial intelligence models used ‘before the start of the game’ include a data purification model, a characteristic extraction model and a first match prediction model, and artificial intelligence models used ‘during the game’ include an emotion analysis model, a body analysis model, a posture analysis model, a motion analysis model, an audio analysis model, a speaker analysis model and a second match prediction model.

In order to execute any function required for broadcasting a fighting video according to the present invention, the processor 233 may activate at least one artificial intelligence model in the artificial intelligence model storage 430 through an API call and transmit at least a portion of the broadcasting video as input data of the relevant artificial intelligence model, thereby acquiring the result data of the relevant artificial intelligence model. A data purification model and a characteristic extraction model may be used to execute the player analysis function of the processor 233, and an emotion analysis model, a body analysis model, a posture analysis model and a motion analysis model may be used to execute a game flow analysis function. In addition, an audio analysis model and a speaker analysis model can be used to execute the game place analysis function, and the first game prediction model and the second game prediction model can be used to execute the game result prediction function.

Meanwhile, in any two artificial intelligence models, the result data of one artificial intelligence model can be used as input data of the other artificial intelligence model. As an example, the result data of the data purification model and characteristic extraction model are used as input data of the first game prediction model. As other example, the result data of the posture analysis model is used as input data of the motion analysis model. As another example, the result data of the emotion analysis model, body analysis model, and motion analysis model are used as input data of the second match prediction model.

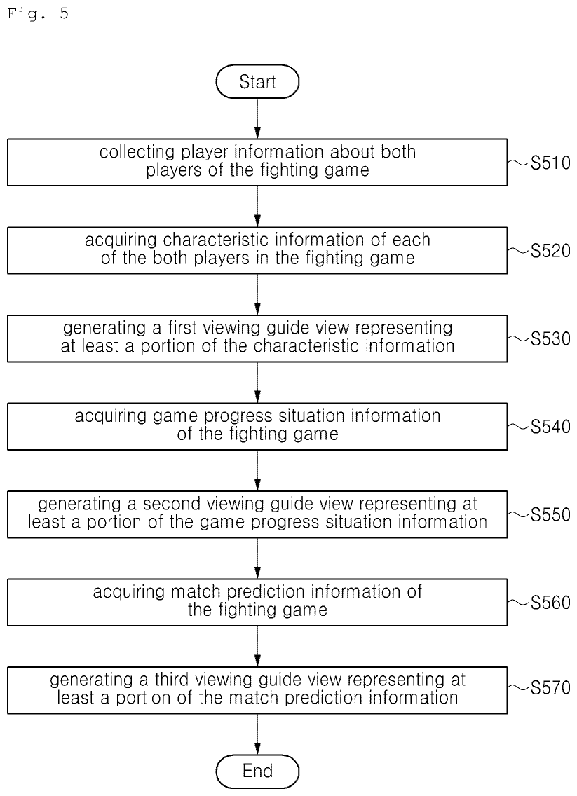

Each artificial intelligence model will be described in more detail later along with the fighting video broadcasting method shown in FIG. 5.

FIG. 5 is a flowchart referenced to illustratively explain a fighting video broadcasting method according to an embodiment of the present invention. The method of FIG. 5 may be executed by the broadcasting apparatus 200 shown in FIGS. 1 and 2.

Referring to FIG. 5, in step S510, the processor 233 collects player information about both players of the fighting game before the start of the fighting game. Specifically, when the processor 233 requests player information about both players from at least one of the SNS server 410 and the media server 420 through the communication unit 210, the SNS server 410 or the media server 420 that received the request may collect relevant information for each player recorded online within a predetermined period from the time of the request and then reply the information to the broadcasting apparatus 200. The broadcasting apparatus 200 may record player information received from at least one of the SNS server 410 and the media server 420 in the memory 232. Also, the processor 233 may collect the fighting game and the history/profile information of both players participating in the game from the fighting information database 220.

In step S520, the processor 233 acquires characteristic information of each of the both players in the fighting game based on the player information collected in step S510.

Specifically, the processor 233 can activate the artificial intelligence model necessary to extract the characteristic information from the player information through an API call. The artificial intelligence model activated by this may be a data purification model and a characteristic extraction model. The processor 233 may input the player information collected (aggregated) in step S510 into a data purification model and then filter out, at least partly, noisy information among the already collected player information. For example, the data purification model can remove, from the player information, information whose relevance to both players is below the standard level (e.g., posts related to players with the same name, player's interviews several years ago, etc.). The player information purified by the data purification model is inputted to the characteristic extraction model, and the characteristic extraction model may extract characteristic information about each player of both players from the purified player information and return it as a result value. Characteristic information for each player may include, for example, physical strengths and weaknesses, main skills, and strengths and weaknesses compared to the opposing player.

In step S530, the processor 233 may generate a first viewing guide view representing at least a portion of the characteristic information. The first viewing guide view is what extracted from characteristic information for each player and may include at least one of the fighting characteristic keyword, the level of the fighting characteristic keyword and the winning probability of at least one of the two players in the fighting game. For example, if the main skill of one of the two players is ‘jab’, ‘jab’ is expressed as the fighting characteristic keyword, and the ratio of the relevant player's ‘jab’ success rate compared to the average success rate of ‘jab’ in the entire player pool is expressed as the level of the fighting characteristic keyword., and the objects visualized for them may be included in the first viewing guide view.

The processor 233 can acquire the match prediction results of both players prior to the start of the fighting game by activating the first match prediction model through an API call and inputting characteristic information into the first match prediction model. In other words, unlike the second match prediction model which will be described later, the first match prediction model may be an artificial intelligence model that has been pre-learned to generate a prediction result value about which player will win, how and when the opponent will win. For example, in case that player A has an advantage in physical specifications such as a longer reach compared to player B, whilst player B won by KO in the first round by kick in a past game against player C having similar physical specifications to player A, the first match prediction model may predict the game between player A and player B by using the physical specifications of each player, past winning/losing history, winning/losing factors, etc. of both players as analysis factors. The first match prediction model may be what learned to predict the match for each fighting game as well as the progress time until the match is decided.

The first viewing guide view is generated before the actual start of the fighting game, and the user terminal 300 may receive the first viewing guide view in a preparation situation (e.g., player introduction, player entrance) of the fighting game. That is, the user may manipulate the user terminal 300 for the first viewing guide view to be displayed simultaneously when the broadcasting video in the game preparation situation is displayed on the screen of the user terminal 300.

In step S540, the processor 233 processes the fighting video to acquire game progress situation information of the fighting game. Processing of the fighting video may mean processing the video by a computer vision (CV).

The game progress situation information is expressed in the fighting video during the fighting game, and includes (i) first progress situation information indicating the status of both players, and (ii) second progress situation information indicating the attack/defense situation between the two players and (iii) third progress situation information indicating the stadium environment where the fighting game is held.

At least one of an emotion analysis model and a body analysis model may be used to acquire the first progress situation information.

The processor 233 can detect the emotional state of each player in a fighting game by inputting the fighting video into an emotion analysis model. The emotion analysis model can identify the countenance and complexion of each player on a frame-by-frame or clip-by-clip basis in a fighting video, and map the identified countenance and complexion of each player to any one of a plurality of emotion clusters. For example, after exploring the face region in the player region of each frame of the emotion analysis model, points corresponding to predetermined feature values within the face region are marked as main key points, and the emotional state corresponding to the combination of the set of key points and the complexion can be specified (inferred). Multiple emotion clusters represent emotion types such as excitement, anger, tension and pain. The emotion analysis model may be learned from a large amount of image data set (e.g., released complexion data set) and may be continuously advanced through a learning process by the broadcast video of new fighting game.

The processor 233 may detect the physical condition of each player in a fighting game by inputting the fighting video into a body analysis model. The body analysis model may identify the color of a given body part (e.g., face, neck, upper body and calf) of each player on a frame-by-frame or clip-by-clip basis in a fighting video, and map the identified color of the body part to any one of a plurality of body state clusters. Each body state cluster may represent a type of body state such as heart rate, injured region, remaining stamina, etc. Like the emotion analysis model, the body analysis model may also be learned from a large amount of image data set and may be continuously advanced through a learning process by the broadcast video of new fighting game.

The emotion analysis model and the body analysis model may be pre-learned to detect the emotional state and physical state of each player under the condition that the rate occupied by each player's region within the video frame inputted to the models is greater than the standard value.

At least one of a posture analysis model and a motion analysis model may be used to acquire the second progress situation information.

The processor 233 may detect the fighting posture of each player in a fighting game by inputting the fighting video into the posture analysis model. The posture analysis model may detect the posture of each player in real time by identifying the joint position of each player on a frame-by-frame or clip-by-clip basis of the fighting video and projecting the identified joint position of each player onto multiple skeletons. The posture analysis model may map the posture of each player to any one of a plurality of posture clusters. As an example, the posture analysis model may search the player region for each video frame, extract the searched player region as a bounding-box, etc., and then specify a region of interest (RoI) within the player region and remove the background to thereby separate only the player portion. Next, the posture analysis model may identify the skeleton structure by setting key points representing the joint positions from the player's portion and connecting these key points with straight lines. The skeleton structure identified in this way is classified into any one of a plurality of posture clusters. A plurality of posture clusters represent the types of posture such as, for example, a punch preparation posture, a takedown defense posture, a kick preparation posture, and a choke completion posture. For reference, even if the posture is the same, the number of key points (e.g., 1 to 18) of the joint region that can be extracted from the video frame may vary depending on the filming angle. Therefore, the posture analysis model may have been sufficiently learned using image data sets for multiple angles for each posture.

The processor 233 may input the fighting video into a motion analysis model and detect the movements of each player in the fighting game. The motion analysis model may align the postures of each player detected for each frame of the fighting video in a time series, and map the set of postures aligned in the time series to any one of a plurality of motion clusters so as to correspond to a predetermined number of frame sets. Each of the plurality of movement clusters corresponds to a specific movement type such as punch, jab, low kick, high kick, knee kick, escape, ducking, back choke, triangle choke, kneebar, and armbar. Here, since it is important to identify the start and end points of each fighting movement, it can be said that the pre-learning process of the motion analysis model using a learning data set obtained from past game videos of the same event is essential. At this time, the labeling for the learning data set may have been classified/defined by an expert in the relevant fighting event. The motion analysis model may have been pre-learned to not only distinguish the start and end points in the broadcast video of fighting movement of each player that occur during a fighting game, but also output the name of the fighting movement as result data. Further, the motion analysis model may also extract additional information such as time length, speed and completeness of the relevant movement, in addition to the name of the fighting movement.

At least one of an audio analysis model and a speaker analysis model may be used to acquire a third progress situation information.

The processor 233 may input fighting video (particularly, audio signal in the video) into an audio analysis model, remove noise other than human speech based on waveform characteristic from audio signals collected through a microphone equipped in the filming system 100 during the fighting game, and then convert a speech signal uttered by at least one of the player, referee, coach, and audience from among the audio signals from which the noise has been removed into a text (speech to text: STT).

The audio signal of the fighting video reflects not only the sounds generated by both players within the fighting stage (e.g., the octagon in the UFC, the quadrilateral ring in boxing), but also the shouts of the spectators in the auditorium surrounding the fighting stage. An audio analysis model may separate conversational and non-conversational components (e.g. shouts) from the audio signal. The processor 233 may acquire the volume of shouts or emotions corresponding to the shouts (e.g., supporting, booing, cheering) from before the start of the fighting game until just before the end thereof as a third s situation information.

The processor 233 inputs the speech signal extracted by the audio analysis model from the audio signal of the fighting video to the speaker analysis model, and identifies a speaker as an utterance source of the speech signal among the player, referee, coach, and spectator of the fighting game. When a face of at least one of player, referee, coach and spectator is detected in the time section in which the relevant speech signal has been extracted, the processor 233 may determine who uttered the relevant speech signal by comparing the speech content estimated based on the mouth shape of the detected face with the text corresponding to the relevant speech signal.

Alternatively, the speaker analysis model may be pre-learned using speech data of both players, referee and coach which had been previously acquired through past games or interviews, etc., as a learning data set. In addition, taking note that as the fighting game progresses, the breathing of both players becomes unstable, while the breathing of the coach and referee will remain relatively stable, the speaker analysis model can primarily distinguish whether the speech signal was uttered by a player or a referee or coach based on the tone/pitch of the voice signal.

In step S550, the processor 233 generates a second viewing guide view representing at least a portion of the game progress situation information. For example, the second viewing guide view may include a graphic object that represents the current remaining health relative to the both players' initial health (at the start of the game) as a bar-shaped gauge, etc. As another example, in the second viewing guide view, a text corresponding to the conversational speech of a coach who coaches his own player during a break between rounds may be displayed as a pop-up speech bubble near the mouth of the coach appearing in the fighting video displayed on the screen of the user terminal 300 or may be displayed in the form of subtitles at the bottom, etc. of the screen.

In step S560, the processor 233 inputs the game progress situation information acquired in step S540 to a second match prediction model and acquire the match prediction information including at least one of the winning probability (e.g., player A 78%) of at least one of the two players in the fighting game, the type of winning (e.g., player A's winning by KO) and the remaining time until the decision of winning or losing (e.g., 3 minutes and 17 seconds). The match prediction information may further include the rationale data therefor. Unlike the first match prediction model, the second match prediction model synthesizes real-time observation information from the player's aspect, game situation aspect and stadium atmosphere aspect according to the actual progress aspect of the fighting game, and outputs while adjusting periodically or non-periodically information that guides viewers about which player will win, when and how during the actual progress of a fighting game. In other words, the second match prediction model has been pre-learned based on a deep learning algorithm through the use of algorithms such as Multi-Scale Multi-View Deep Feature Aggregation (MSMVFA) so as to provide prediction value on how the currently ongoing fighting game will develop in the future based on its input data.

If it has been predicted that the probability of winning is above a reference value (e.g., 40%) and that the type of winning is knock out or submission, the remaining time until the decision of winning or losing may also be predicted. This is because if the type of winning is neither knock out nor submission, the winning is a winning made by decision and thus there is no need to predict the remaining time.

In step S570, the processor 233 generates a third viewing guide view representing at least a portion of the match prediction information acquired in step S560. The third viewing guide view may include at least one of a graphic object representing the winning (or losing) player of both players, a graphic object representing the type of winning (or losing), and a graphic object representing the remaining time until the decision of winning or losing. Additionally, when it is determined that the likelihood that a particular player will win (or loss) against an opposing player is high, the third viewing guide view may further include a graphic object representing the reason for such decision result. For example, if player A is predicted at 4 minutes 10 seconds of round 3 to win by KO against player B in the time period of 2 minutes 30 to 40 seconds of round 4, the number of effective hits inflicted by player A on player B (can be expressed per unit time), physical damage to player B caused by the effective hits (e.g., degree of injury and site of injury) and changes in player B's facial expression over the time period from the start of round 1 to 4 minutes and 10 seconds of round 3 may be displayed on the screen of the terminal 300

Information (objects) presented to the user through the third viewing guide view may be hierarchically organized. For example, some of the match prediction information such as the user's request for prediction of a player who will win the game→displaying “player A having 60% probability of winning”→the user's request for the type of winning→displaying that “80% probability of winning by KO and 11% probability of winning by decision→the user's request for information on remaining time→displaying “90% probability that the match will be decided between 25 and 45 seconds” may be displayed on the screen of the user terminal 300 in stages according to the user's manipulations applied to the user terminal 300.

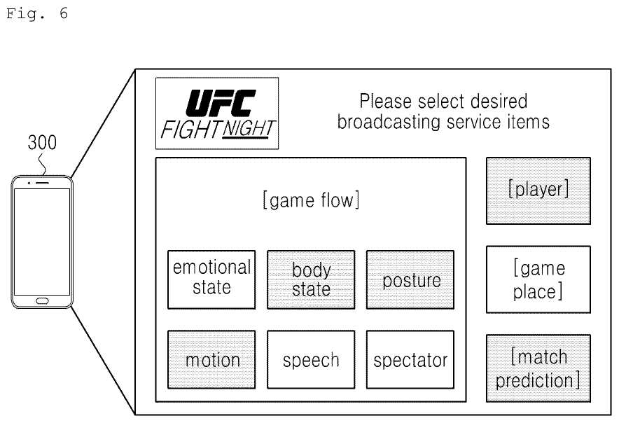

FIGS. 6 to 8 drawings referenced to exemplarily explain m illustrate the screen configuration of the user terminal 300 that connects to the fighting video broadcasting apparatus 200 shown in FIG. 1 through a wired or wireless communication network and receives a fighting video broadcasting service.

FIG. 6 is a diagram referenced to exemplarily explain the broadcasting service setting window displayed on the screen of the user terminal 300. Users can set the fighting video broadcasting service to their preference by manipulating the setting window.

Referring to FIG. 6, graphic objects corresponding to each of the four top categories of the fighting game, that is, player/game flow/game place/match prediction, may be displayed on the screen of the user terminal 300, and the user can select whether or not to present a viewing guide view for each category by generating click or touch event. In addition, the user can select whether to display on the screen a viewing guide view that represents information inferred (generated) by artificial intelligence models regarding each sub-items (emotional state/body state/posture/motion/speech/spectator) of a specific category (“game flow”). In FIG. 6, information about body state/posture/motion has been set to be displayed in the second viewing guide view, while information about emotional state/speech/spectator has been excluded from being displayed in the second viewing guide view.

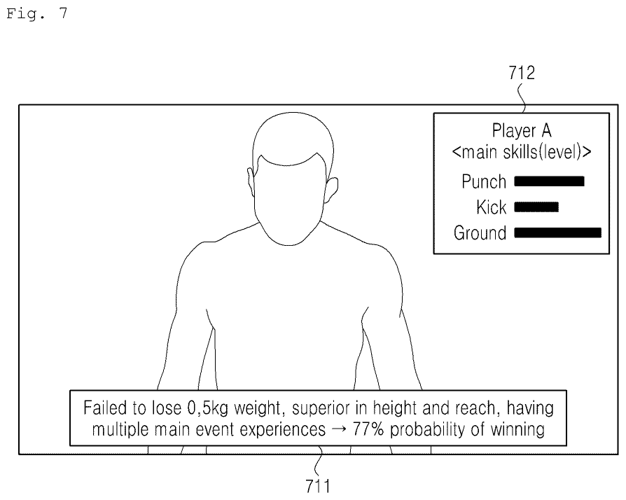

FIG. 7 illustrates a screen configuration of the user terminal 300 in a situation before the start of a fighting game. When explaining based on the UFC, it takes about 10 minutes from introducing both players to their entrance, etc. before the first round begins.

The processor 233 may identify players appearing in the video frame through processing of each video frame of the broadcast video collected before the start of a fighting game, and provide a first viewing guide view representing characteristic information acquired in advance about the identified player to the terminal 300. The first viewing guide views 711 and 712 may be presented in the form of subtitles at the bottom of the screen or in a portion that does not overlap with the player region. FIG. 7 illustrates that punch/kick/ground are selected as characteristic keywords, and a 77% probability of winning based on weigh-in information/body specification and past game history is provided to viewers as additional information.

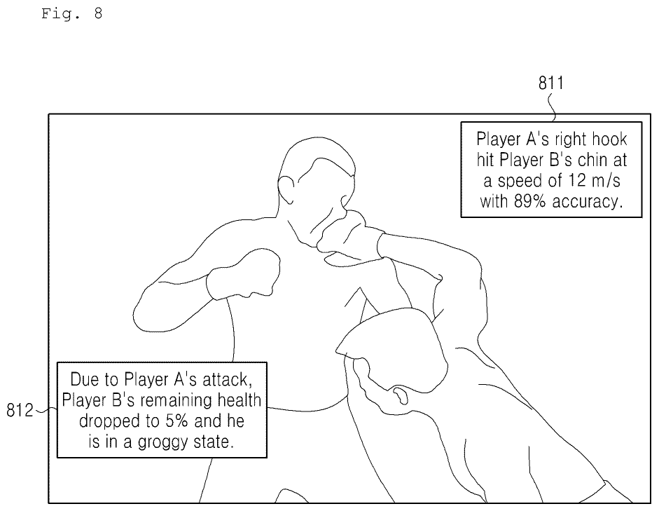

FIG. 8 illustrates a screen configuration of the user terminal 300 in the situation where a fighting game is in progress. Referring to FIG. 8, in an attack and defense situation between both players (player A and player B), when player A's attack hits player B, a second viewing guide view 811 representing a player who performs the attack (“player A”), the name of the attack technique (“right hook”), attack speed (“12 m/s”), striking site (“chin”), attack accuracy (“89%”), etc. may be displayed overlapping a portion of the fighting video.

The processor 233 may detect changes in the facial expression and striking site of the opposing player in the image frame connected to the sections in the broadcast video in which the attacking movement of a specific player and striking site are identified, thereby estimating the accuracy of the attacking movement of the specific player and the level of damage to the opposing player's body caused by the attack. Additionally, a second viewing guide view 812 indicating the state of the opposing player who has been hit by the attack technique (“the remaining health drops to 5% and is in a groggy state”) may be additionally displayed.

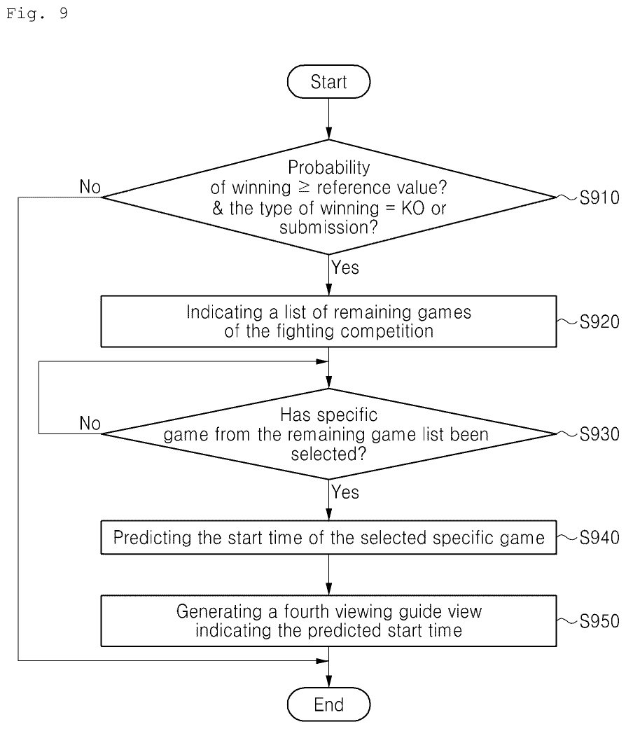

Meanwhile, in a fighting tournament, as described above, several fighting games are held in order, and viewers may wish to watch only specific game rather than all games of the fighting tournament. However, unlike other sports, in fighting games situations frequently occur where the game cannot be continued before the stipulated time expires. For example, in a 5-minute, 5-round fighting game, the game may end in the middle of the round 3 due to a specific player's KO. Because of this, viewers may have the inconvenience of having to check from time to time the situation of preceding fighting games that are unnecessary for viewing in order to avoid missing the fighting game they want to watch. The method of FIG. 9 described below is intended to solve the problem mentioned above.

FIG. 9 is a flowchart schematically showing a method of broadcasting a fighting video according to another embodiment of the present invention. The method of FIG. 9 may be executed after step S560 of FIG. 5.

Referring to FIG. 9, in step S910, the processor 233 may determine whether the probability of winning for the currently ongoing fighting game is greater than a reference value and whether the type of winning is predicted to be knockout or submission. If the value of step S910 is “Yes,” the process proceeds to step S920.

In step S920, the processor 233 provides a list of remaining games of the same fighting competition as the currently ongoing fighting game. For example, if a fighting competition includes a total of 8 bouts, and the second bout is currently ongoing, a list of 6 pending bouts may be displayed in the broadcast video.

In step S930, the processor 233 determines whether a specific game from the remaining game list has been selected by the user terminal 300. For example, if the user clicks or touches the fourth game presented in the list of remaining games, step S930 is determined as “Yes.” If the value of step S930 is “Yes,” the process proceeds to step S940.

In step S940, the processor 233 predicts the start time of the specific game selected in step S930 based on the remaining time until determination of the winning or losing of the currently ongoing game. For example, let's assume that the current game is the second game of the tournament and the remaining time is predicted to be 3 minutes, and the specific game selected in step S930 is the fourth game of the tournament. Then only a single game is waiting between the current game and the specific game selected in step S930. In this case, the remaining time until the start time of the fourth game=remaining time of the current game (second game)+progress time of the third game+(waiting time between games*2). The progress time of the third game may be set equal to the average progress time per game based on past information of the same fighting games. Alternatively, the expected progress time may be estimated by the first match prediction model together with the match prediction result of the third game. The waiting time between games is the time from the end of the previous game until the start of the next game in two adjacent games, and this can also be determined statistically from past game history.

In step S950, the processor 233 generates a fourth viewing guide view indicating the start time predicted in step S940.

The fourth viewing guide view, like the first to third viewing guide views, is displayed on the screen of the user terminal 300 and can help the user smoothly watch the fighting video.

Alternatively, instead of generating the fourth viewing guide view in step S950, the processor 233 may notify (alarm setting command) the user terminal 300 of the predicted start time in step S940, and the user terminal 300 can set an automatic alarm according to the start time of a specific game notified by the broadcasting apparatus 200.

The present invention is not limited to the specific embodiments and application examples described above, and various modifications can be made by those skilled in the art without departing from the gist of the present invention as claimed in the claims. Of course, these modified implementations should not be understood separately from the technical idea or outlook of the present invention.

In particular, configurations that implement the technical features of the present invention included in the block diagram and flow chart shown in the drawings attached to this specification represent logical boundaries between the configurations. However, according to an embodiment of the software or hardware, the depicted configurations and their functions are executed in the form of stand-alone software modules, monolithic software structures, codes, services and combinations thereof, and their functions can be implemented by being stored in a medium executable on a computer having a processor that can execute stored program code, instructions, etc., and therefore, all of these embodiments should also be regarded as falling within the scope of the present invention.

Accordingly, although the attached drawings and their descriptions illustrate the technical features of the present invention, the specific arrangement of the software to implement these technical features should not be simply inferred unless explicitly stated. In other words, various embodiments described above may exist, and since such embodiments may be partially modified while retaining the same technical features as the present invention, these should also be regarded as falling within the scope of the present invention.

Further, in the case of a flowchart, operations are depicted in the drawing in a specific order, but this is shown to obtain the most desirable results. It should not be understood that such operations must be performed in the specific order or sequential order as shown, or that all illustrated operations must be necessarily performed. In certain cases, multitasking and parallel processing may be advantageous. Additionally, the separation of various system components in the embodiments described above should not be construed as requiring such separation in all embodiments, and it should be understood that the program components and systems as described can generally be integrated together into a single software product or packaged into multiple software products.

1. A method of broadcasting a fighting video obtained by filming a fighting game in which both players compete according to established rules, which is executed by a fighting video broadcasting apparatus, comprising the steps of:
acquiring characteristic information about each of both players in the fighting game based on player information collected in advance before the start of the fighting game;
generating a first viewing guide view representing at least a portion of the characteristic information;
processing the fighting video to obtain game progress situation information of the fighting game; and
generating a second viewing guide view representing at least a portion of the game progress situation information.

2. The method according to claim 1, wherein the player information includes at least one of physical specification for each player, winning/losing history, fighting style, attack attempt/success history for each game, defense attempt/success history for each game, progress time for each game and game preparation situation, wherein the characteristic information includes at least one of physical strength and weakness, special skill and strength and weakness compared to the opposing player, and wherein the game progress situation information includes at least one of the emotional state, body state, and attempted attack and defense technique for each player.

3. The method according to claim 1, wherein the first viewing guide view includes at least one of a fighting characteristic keyword of at least one of the both players in the fighting game, a level of the fighting characteristic keyword and a winning probability, which are extracted from the characteristic information.

4. The method according to claim 1, wherein the game progress situation information includes at least one of a first progress situation information representing the player status of both players, a second progress situation information representing the attack and defense situation between the both players and a third progress situation information representing a stadium environment where the fighting game is held, which are expressed in the fighting video during the fighting game.

5. The method according to claim 4, wherein the step of acquiring game progress situation information of the fighting game comprises:
inputting the fighting video into an emotion analysis model to detect the emotional state of each player in the fighting game; and
inputting the fighting video into a body analysis model to detect the physical condition of each player in the fighting game, wherein the first progress situation information represents at least one of the emotional state and the physical state for each player,

6. The method according to claim 4, wherein the step of acquiring game progress situation information of the fighting game comprises:
inputting the fighting video into a posture analysis model to detect a fighting posture for each player in the fighting game; and
inputting the fighting video into a motion analysis model to detect fighting movement for each player in the fighting game, wherein the second progress situation information represents at least one of the fighting posture and the fighting movement for each player.

7. The method according to claim 4, wherein the step of acquiring game progress situation information of the fighting game comprises:
inputting the fighting video into an audio analysis model to convert speech signal uttered by at least one of a player, referee, coach and spectator during the fighting game into text; and
inputting the speech signal into a speaker analysis model to identify a speaker as an uttering source of the speech signal among the player, referrer, coach and spectator, wherein the third progress situation information represents at least one of the text and the speaker.

8. The method according to claim 1, further comprising the step of mapping at least one of the first viewing guide view and the second viewing guide view to an image section of the fighting video corresponding thereto

9. The method according to claim 1, further comprising the steps of inputting the game progress situation information into a match prediction model to thereby acquire a match prediction information including at least one of the probability of winning of at least one of the both players in the fighting game, the type of winning, and the remaining time until before the decision of winning or losing; and
generating a third viewing guide view representing at least a portion of the match prediction information.

10. The method according to claim 9, wherein the remaining time until the decision of winning or losing is predicted in the condition that the probability of winning is greater than a reference value and the type of winning has been predicted as a knock out (KO) or submission.

11. The method according to claim 9, further comprising the steps of:
predicting a start time of other fighting game scheduled after the fighting game based on the remaining time until the decision of winning or losing; and
generating a fourth viewing guide view representing the predicted start time for the other fighting game.

12. An apparatus for broadcasting a fighting video obtained by filming a fighting game in which both players compete according to established rules, comprising:
a memory storing a computer program in which instructions for executing a fighting video broadcasting method are recorded; and
a processor operably coupled to the memory,
wherein when the computer program is executed by the processor, the computer program causes the processor to
acquire characteristic information about each of both players in the fighting game based on player information collected in advance before the start of the fighting game;
generate a first viewing guide view representing at least a portion of the characteristic information;
process the fighting video to acquire game progress situation information of the fighting game; and
generate a second viewing guide view representing at least a portion of the game progress situation information.

13. The apparatus according to claim 12, wherein the first viewing guide view includes at least one of a fighting characteristic keyword of at least one of the both players in the fighting game, a level of the fighting characteristic keyword and a winning probability, which are extracted from the characteristic information.

14. The apparatus according to claim 12, wherein the game progress situation information includes at least one of a first progress situation information representing the player status of both players, a second progress situation information representing the attack and defense situation between the both players and a third progress situation information representing a stadium environment where the fighting game is held, which are expressed in the fighting video during the fighting game.

15. The apparatus according to claim 12, wherein the computer program causes the processor to input the game progress situation information into a match prediction model to thereby acquire a match prediction information including at least one of the probability of winning of at least one of the both players in the fighting game, the type of winning, and the remaining time until before the decision of winning or losing; and
generate a third viewing guide view representing at least a portion of the match prediction information.
